(19) United States
(12) Patent Application Publication
(10) Pub. No.: US 2010/0297435 A1
(43) Pub. Date: Nov. 25, 2010

(54) NANOTUBES AND RELATED MANUFACTURING PROCESSES

(76) Inventors: Anupama B. KAUL, Arcadia, CA (US); Krikor G. Megerian, Glendale, CA (US); Paul A. Von Allmen, Palmdale, CA (US); Richard L. Baron, La Crescenta, CA (US)

Correspondence Address: Steinfl & Bruno, 301 N Lake Ave Ste 810, Pasadena, CA, 91101, US

(21) Appl. No.: 12/694,235

(22) Filed: Jan. 26, 2010

Related U.S. Application Data
(60) Provisional application No. 61/206,115, filed on Jan. 28, 2009.

(51) Int. Cl. C03C 25/44; B01J 37/34; H05H 1/34; C03C 25/68

(52) U.S. Cl. 428/332; 502/5; 427/577; 216/67; 977/932

(57) ABSTRACT

Nanotubes and related nanofabrication processes are described where wafer-scale approaches have been developed. The described processes can be used to produce single, vertically aligned tubes integrated into 3D nano-scale architectures. Moreover, fabrication processes to generate 3D nanoarchitectures are also described.

### CROSS REFERENCE TO RELATED APPLICATIONS

The present application claims priority to U.S. Prov. App. No. 61/206,115 filed on Jan. 28, 2009, which is incorporated herein by reference in its entirety.

### STATEMENT OF GOVERNMENT GRANT

The invention described herein was made in the performance of work under a NASA contract, and is subject to the provisions of Public Law 96-517 (35 USC 202) in which the Contractor has elected to retain title.

### FIELD

The present disclosure relates to nanotubes. More in particular, the present disclosure relates to nanotubes and related manufacturing processes.

### BACKGROUND

The constant drive toward miniaturization driven primarily by the microelectronics industry has created niche opportunities for nanoscale materials, such as carbon nanotubes (CNTs) that show promise as interconnects (see reference 1, incorporated herein by reference in its entirety), novel transistors (see reference 2, incorporated herein by reference in its entirety), or heat transport materials (see reference 3, incorporated herein by reference in its entirety). A heavily utilized technique for the synthesis of carbon nanotubes, specifically multi-walled-nanotubes (MWNTs), is thermal chemical vapor deposition (CVD), which results in bundles of tubes largely perpendicular to the substrate and growing in more-or-less random directions.

A technique which has emerged in recent years to ensure excellent vertical tube alignment is plasma-enhanced (PE)-CVD (see reference 5, incorporated herein by reference in its entirety), where the inherent electrical field in the plasma allows tube growth in a direction parallel to the field. Analysis of crystallinity of individual tubes reveals graphitic structures where the graphene layers are inclined to the central axis (see references 4 and 6, incorporated herein by reference in their entirety). These structures are commonly referred to as carbon nanofibers (CNFs) and control over their physical orientation with the plasma is excellent. Various plasma sources have been employed for tube or CNF growth, such as microwave, inductively coupled plasma (ICP), dc and dc with hot filament. A comprehensive review of the PECVD technique for tube synthesis can be found in reference 7, incorporated herein by reference in its entirety.

Besides the ability to direct growth orientation, another important figure of merit for many applications is the precise control over tube placement. There have been many reports on the PECVD growth of multiple tubes formed at controlled locations using positive tone novalac/diazoquinone-based or negative tone rubber/azide resists; AZ 5214 or AZ 5206 are examples of such resist systems (see reference 8, incorporated herein by reference in its entirety).

To date, e-beam lithography has been the main technique implemented for catalyst definition for the realization of arrays of individual, free-standing, vertically aligned CNTs or CNFs using PECVD (see reference 9, incorporated herein by reference in its entirety). Moreover, in reports to date, single, vertically aligned tubes formed with PECVD have typically been grown on planar 2D substrates.

Some applications involve engineering of certain nanotubes characteristics. Some examples of such characteristics are the extent to which they emerge above the electrodes, the diameters of the nanotubes. Modification of these characteristics impact the mechanical properties of the nanotubes. These characteristics have been controlled to some extent, by adjusting the CVD growth parameters, such as growth pressure, catalyst thickness, and power. As an example, FIG. 7 is an SEM image showing tubes of diameters ranging from 200 nm down to only 40 nm, which resulted from varying growth parameters Also, as is evident from this figure, a tip growth mechanism was operative, where the nominally pear-shaped (see reference 10, incorporated herein by reference in its entirety) nickel cap, remains on the tip as the tube grows.

The growth model for PECVD tubes (see references 10 and 11 incorporated herein by reference in their entirety) suggests decomposition of hydrocarbons at the catalyst surface causing carbon adsorption, which is followed by surface and bulk diffusion of carbon into the nanoparticle. Precipitation of carbon from the supersaturated nanoparticle results in nanotube growth at the tip. It is likely that an increase in pressure causes the surface and bulk diffusion constants to increase, causing the tube growth rate to also increase with pressure. However, at sufficiently high pressure, growth rate is saturated possibly due to the carbon solid solubility limit, where the extra carbon within the nanoparticle can deposit directly on the catalyst surface; this would prevent subsequent diffusion and limit growth rate. A linear increase in growth rate has been noticed for pressures less than 10 Torr (see reference 12, incorporated herein by reference in its entirety).

### SUMMARY

According to a first aspect, a method for fabricating vertically aligned carbon nanotubes is provided, comprising: providing a growth chamber; providing a sample wafer comprising a catalyst patterned on a substrate inside the chamber; reducing a surface oxide on the catalyst by performing a pretreatment with hydrogen plasma at a pretreatment temperature; setting chamber temperature at a growth temperature; setting chamber pressure to a desired chamber pressure to introduce a carbon containing gas and a diluent gas into the chamber; introducing the carbon containing gas and the diluent gas into the chamber; setting the chamber pressure to a growth chamber pressure; initiating a growth of the vertically aligned nanotubes from the catalyst by igniting an electric glow discharge; and continuing the growth for a set duration.

According to a second aspect, a method of fabricating high aspect ratio nanostructures is provided, comprising: providing a wafer comprising a substrate, the substrate underlying a stack of a deposited device layer on an oxide layer; coating the wafer with an under-layer; coating the under-layer with a positive tone chemically amplified resist; defining the structures by patterning and exposing the positive tone chemically amplified resist; developing the positive tone chemically amplified resist; etching the device layer; minimizing a lateral etch rate by enhancing a formation of a passivation layer; forming the high aspect ratio nanostructures with widths of less than 400 nm; recoating the wafer with the positive tone chemically amplified resist; and etching the oxide layer.

According to a third aspect, a method of fabricating catalyst nanoclusters within high aspect ratio 3D nanostructures comprising: providing a wafer comprising high aspect ratio nanostructures on a substrate; providing a catalyst; coating the wafer with an under-layer; coating the under-layer with a negative tone chemically amplified resist; defining nanocluster patterns and exposing the negative tone chemically amplified resist to broadband ultraviolet (UV); developing the negative tone chemically amplified resist; re-exposing the wafer to broadband UV; dissolving a remaining of the under-layer; depositing the catalyst nanoclusters; monitoring a thickness of the catalyst nanoclusters until a desired thickness is reached; cooling the wafer; and lifting off the remaining of the under-layer and the negative tone chemically amplified resist.

According to a fourth aspect, a 3D nanostructure is provided, comprising: a substrate underlying two multi-layer electrodes comprising each a stack of a deposited device layer on an oxide layer; and a single vertically aligned nanotube centered between the two electrodes, wherein the two electrodes are up to 3 μm high and are less than 800 nm apart from each other, and the nanotube is less than 300 nm wide and placed at a distance of of 100 nm or more from any of the two electrodes.

According to a fifth aspect, 3D nanoarchitecture is provided comprising: a plurality of nanostructures on a substrate, each of the plurality of nanostructures comprising: two multi-layer electrodes each comprising a stack of a deposited device layer on an oxide layer; and a single vertically aligned nanotube centered between the two electrodes, wherein the electrodes are up to 3 μm high and are less than 800 nm apart from each other, and the nanotube is less than 300 nm wide and placed in a distance 100 nm or more from any of the two electrodes.

Further aspects of the present disclosure are shown in the description, drawings and claims of the present application.

### BRIEF DESCRIPTION OF FIGURES

FIG. 1 shows a schematic cross-sectional view of a load-lock based plasma-enhanced chemical vapor deposition (PECVD) growth system.

FIG. 2A shows an SEM image of unaligned grown nanotubes.

FIG. 2B shows an SEM image of vertically aligned grown nanotubes.

FIG. 3C shows a dc glow discharge and plots of plasma power vs. CNT growth time.

FIG. 3A shows an SEM image of an array of 300 nm wide Ni catalyst nanoclusters

FIG. 3B shows an atomic force microscope (AFM) scan of an array of approximately 400 nm wide Ni catalyst nanoclusters that nucleated single, vertically aligned nanotubes as shown in FIG. 3C.

FIG. 3C shows vertically aligned nanotubes.

FIG. 3D shows a plot of nanotube length vs. growth time.

FIGS. 4A-B show SEM images of two electrodes.

FIG. 4C shows a cross-sectional view of an electrode according to an embodiment of the present disclosure.

FIG. 4D shows a cross-sectional view of an electrode according to another embodiment of the present disclosure.

FIG. 5A shows an SEM image of nanoclusters.

FIG. 5B shows an EDS spectrum related to the SEM image of FIG. 5A.

FIG. 5C shows two electrodes with a catalyst nanocluster in between.

FIG. 5D shows registration marks related to a fabrication of nanoclusters.

FIGS. 5E-F show cross sectional views of a wafer.

FIGS. 6A-D show SEM images of electrodes and single nanotubes.

FIG. 7 shows SEM images of nanotubes with varying diameters.

FIG. 8A shows a plot of nanotube length vs. gas pressure.

FIG. 8B shows a plot of nanotube length and diameter vs. a Ni catalyst thickness.

FIG. 8C shows a plot of carbon volume vs. a Ni catalyst thickness.

FIG. 8D shows a plot of nanotube length vs. plasma power.

### DETAILED DESCRIPTION

In what follows, manufacturable approaches to form single, vertically aligned carbon nanotubes (CNT), where the nanotubes are precisely placed on a substrate will be described according to several embodiments of the present disclosure.

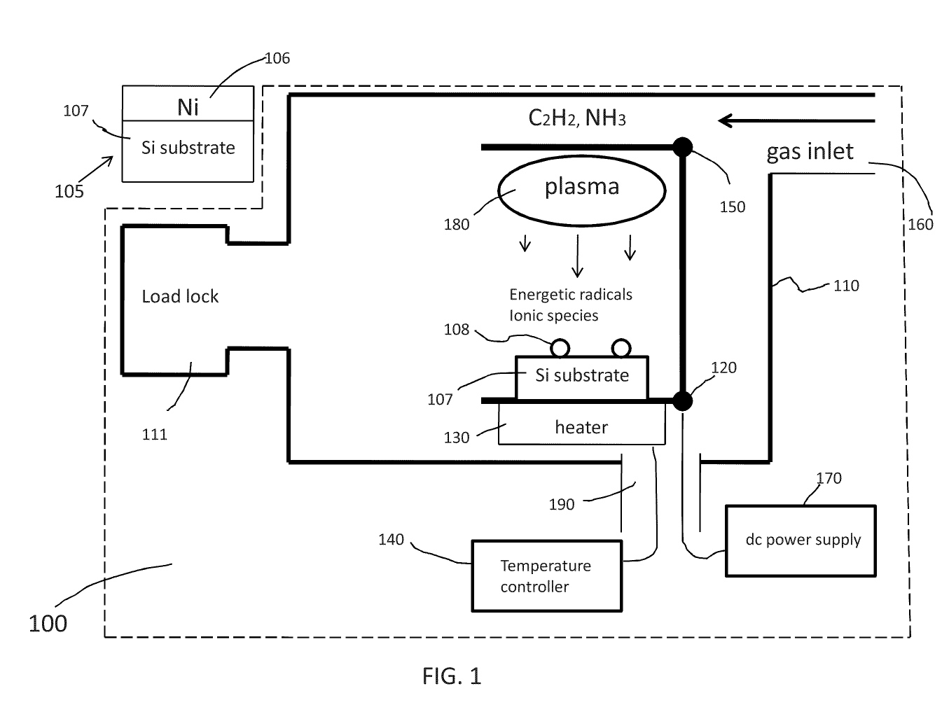

FIG. 1 shows a schematic cross-sectional view of a load-lock based plasma-enhanced chemical vapor deposition (PECVD) growth system (100) in accordance with an embodiment of the present disclosure. The PECVD system (100) comprises a chamber (110), a load lock (111), a temperature controller (140) and a power supply, e.g., a dc power supply (170). According to an embodiment of the present disclosure, a base pressure of around 5×10⁻⁸ Torr can be typically achieved within the chamber (110), although according to other embodiments, the pressure can be as high as 1×10⁻⁶ Torr.

A prepared sample (105) is also shown in FIG. 1. According to an embodiment of the present disclosure, the sample (105) comprises a thin catalyst (106) layer deposited on a substrate (107). By way of example and not of limitation, Ni, Fe, Co, or Cu can be used to provide the thin catalyst (106) layer and a degenerately doped Si wafer (with a resistivity of for example, 1 to 5 mΩ-cm) can be used to provide the substrate (107). Embodiments can also be envisaged wherein the substrate (107) is a two-dimensional (2D) substrate or a substrate with pre-fabricated three-dimensional (3D) features. In other embodiments, the catalyst (106) can be at isolated locations or arranged in an arbitrary or an array configuration across an entire wafer for batch synthesis of tubes in 3D architecture as described later. In accordance with a further embodiment of the disclosure, the substrate diameter or linear dimension can range from 3 mm to 200 mm (8 inches). The person skilled in the art will understand that such diameter range is exemplary and other values and/or ranges can be provided.

Referring to FIG. 1, the sample (105) can be placed, for example, on a 3-inch Mo ring (not shown) in order to be transported from the load lock (111) to the chamber (110) where the sample (105) is lowered and rested onto a holder (120). The holder (120) serves also as a cathode for dc plasma operation. FIG. 1 also shows a resistive heater (130) located underneath the holder (120). A temperature within the chamber (110) is ramped using the temperature controller (140). The applicants used an Athena Controls, Inc. (series 6080) as the temperature controller (140). Further shown in FIG. 1, is an anode (150). In accordance with an embodiment of the present disclosure, the anode (150) is made of a circular metal disk and can be placed approximately five to eight mm above the cathode (120). The anode (150) is electrically isolated.

Further referring to FIG. 1, the chamber (110) further comprises a gas inlet (160) and an electrical feed-through (190). A flow of gases into the chamber (110) is controlled by mass flow controllers (not shown). A pressure during growth is measured with a capacitance manometer (not shown) and controlled by an exhaust valve controller (not shown). The applicants used a Sierra instrument-6514 as the mass flow controller, an MKS PDR-C-2C as the capacitance manometer and a type 152A exhaust valve controller. Plasma (180) was powered by the dc power supply (170), as shown in FIG. 1. The applicants used an Advanced Energy, Inc. (MDX Magnetron Drive) as the power supply (170).

According to an embodiment of the present disclosure, a pretreatment step was carried out prior to carbon nanotube (CNT) growth for 1 to 2 min, where a low power hydrogen plasma (e.g., 60 W, 5 Torr) served to reduce a surface oxide on the catalyst (106) (e.g., Ni) at elevated temperatures (e.g., 700° C.). Throughout the present disclosure, the term ‘growth temperature’ is intended to indicate the temperature inside the chamber (110) while growth of nanotubes is taking place. According to an embodiment of the present disclosure the growth temperature is approximately 700° C., although embodiments where a lower growth temperature is used can also be envisaged.

Following pretreatment, the chamber (110) is pumped out until the pressure is restored to approximately 2×10⁻⁶ Torr, after which point high purity acetylene (C₂H₂) and ammonia (NH₃) are introduced. The acetylene and ammonia served as the carbon-containing and diluent gas, respectively. Other choice of carbon-feedstock gases are ethylene (C₂H₄) or methane (CH₄). In addition, hydrogen (H₂) can be used instead of NH₃ as a reducing agent. According to an embodiment of the present disclosure, a ratio of C₂H₂:NH₃=1:4 is used to minimize the amount of amorphous carbon on the substrate (107) during CNT growth.

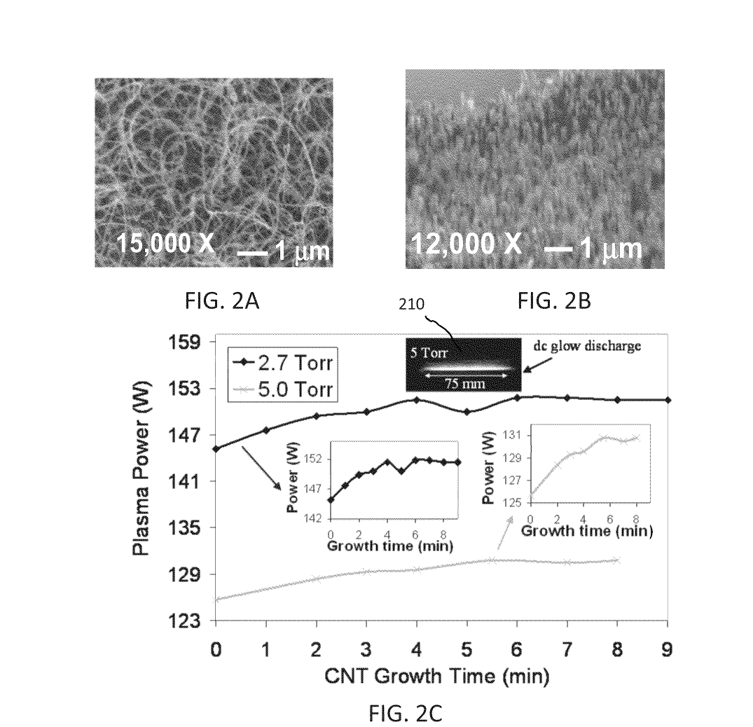

With continued reference to FIG. 1, when a desired growth pressure is attained (e.g., 5 Torr, but can be as low as 1 Torr), a dc glow discharge (210) as shown in an inset of FIG. 2C is ignited and the CNT growth is continued for a fixed duration. Throughout the present disclosure, the term ‘growth pressure’ is intended to indicate the pressure inside the chamber (110) of FIG. 1 while the nanotube growth is taking place. In what follows, a role of the dc glow discharge (210) and temperature in CNT growth is described in accordance with embodiments of the present disclosure.

Referring to FIG. 1, the role of the dc glow discharge (210) is to generate an electric field strong enough to align the CNT's. In the absence of such an electric field, the presence of gases like C₂H₂ and NH₃ at elevated temperatures (for example 700° C.) may result in unaligned tubes as shown in FIG. 2A. In the presence of a stable plasma (180), a 15 nm thick Ni catalyst resulted in a large areal density of vertically aligned tubes, as shown in an SEM in FIG. 2B. As shown in FIG. 2C, a drift in plasma power can be noticed in two curves (220, 230) representing a plasma power as a function of CNT growth time, for two different pressure values within the chamber (110). This drift is attributed to the dynamics of the plasma physics and gas chemistry, as well as possibly the chamber temperature.

Further referring to FIG. 1, elevated temperatures (for example 700° C.) cause the catalyst (106) layer to dissociate into fine catalyst nanoclusters (108) as a result of surface energy driving forces, where the catalyst nanoclusters (108) then serve as nucleation sites for tube growth. The plasma (180) may also aid in catalyst particle fragmentation directly via ion bombardment, which may also then contribute to heating the substrate (107) surface indirectly.

The person skilled in the art will understand that the nanotube fabrication described above is applicable to CVD or other electric-field assisted CVD techniques.

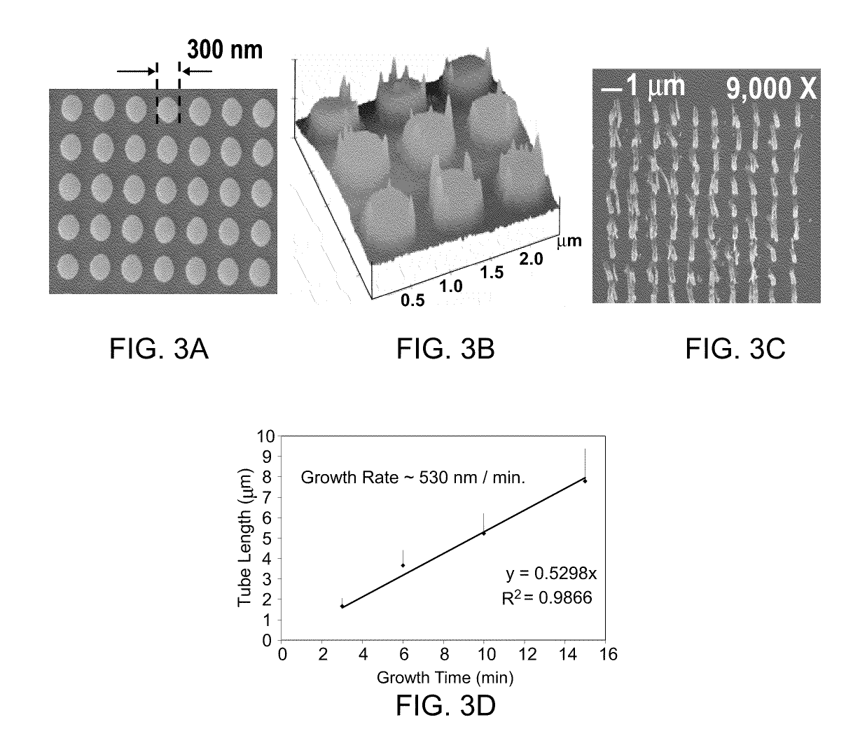

FIG. 3A is an SEM image of an array of 300 nm wide Ni catalyst nanoclusters. FIG. 3B shows an atomic force microscope (AFM) scan of an array of approximately 400 nm wide Ni catalyst nanoclusters that nucleated single, vertically aligned nanotubes as shown in FIG. 3C.

Continuing with the CNT growth procedure as described above, the CNT growth duration can be set to achieve a desired nanotube length. The applicants achieved a growth rate of 530 nm/min. FIG. 3D shows a plot of nanotube length vs. growth time corresponding to the growth rate of 530 nm/min which appears to be within an expected range for dc PECVD grown nanotubes (see reference 7, incorporated herein by reference in its entirety).

With reference to FIG. 1, after the growth is completed, the plasma (180) is turned off, the gases are pumped out to restore vacuum in the chamber (110) and the heater (130) is turned off. The sample (105) can then be transferred into the load lock (111) and nitrogen can be used to vent the load lock (111) back to atmosphere.

In what follows, a formation of 3D, high aspect ratio nanoscale architectures realized using top-down, nano-manufacturable (low-cost, high-throughput) techniques is described. Throughout the present disclosure, a “high aspect ratio structure” is defined as a structure up to 3 μm tall and 400 nm wide with as aspect ratio of up to 1:6. By way of example and not of limitation, high aspect ratio nanoscale architectures can be electrodes of 3 μm height fabricated on a same substrate and within a distance of 800 nm or less from one another.

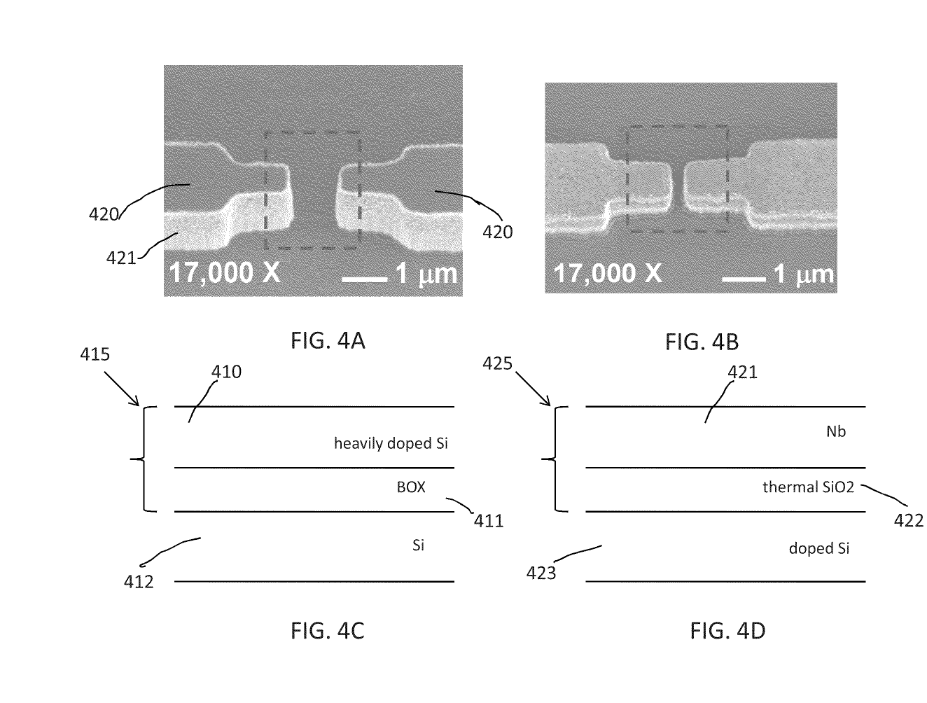

FIG. 4A shows two electrodes (420). In accordance with an embodiment of the present disclosure, as shown in FIG. 4C, the electrode (420) comprises a bilayer stack of a degenerately doped Si layer (410) over a Buried-Oxide (BOX) layer (411) on a Si-handle (412). Exemplary thickness ranges for the Si layer (410) and the BOX layer (411) are 1.0 to 2.0 μm and 0.5 to 1 μm, respectively. In a further embodiment, as shown in FIG. 4D, the electrode (420) comprises a bilayer stack of a deposited Niobium (Nb) film (421), having a thickness in a range of, for example 1 to 2 μm, over a thermal SiO₂ layer (422), with a thickness within a range of, for example, 0.5 to 1 μm, on a Si substrate (423). By way of example and not of limitation, the Si layer (410) of FIG. 4C can have a resistivity of 1 to 5 mΩ-cm. According to an embodiment of the present disclosure, the electrode (420) of FIG. 4A can be 0.4 μm to 1.0 μm wide. Further embodiments can also be envisaged where the electrode (420) is a multi-layer electrode.

Referring to FIG. 4A and FIG. 4C, a positive tone, polyhydroxystyrene resin-based deep UV chemically amplified resist (e.g., AZ 8250), is used to define the electrodes (420) in accordance with an embodiment of the present disclosure. In such resists, enhanced sensitivity at short UV wavelengths (248 nm or less, for example) is possible through a positive amplification process, where a single photon can cause hundreds of acid-catalyzed de-protection reactions that are initiated during post-exposure-baking of the resist. Throughout the present disclosure, the term “positive tone resist” intends to indicate that the regions that are exposed to UV radiation dissolve in developer solution and that in such resists, enhanced sensitivity at short UV wavelengths (248 nm or less, for example) is possible through a positive amplification process, where a single photon can cause hundreds of acid-catalyzed de-protection reactions that are initiated during post-exposure-baking of the resist. Cryogenic deep-trench reactive ion etching (Cryo-DRIE) is implemented where a non-polymeric passivation layer can be utilized for low-bias, fluorine inductively coupled plasmas (ICP). The applicants carried out an etching experiment in a Unaxis Fluorine ICP reactor (P-6857). The etching condition was optimized with an addition of O₂ to SF₆ resulting in a formation of highly anisotropy Si electrodes as shown in FIGS. 4A-B. A Si etch rate of approximately 1.1 μm/min was used. As shown in FIGS. 4A-B, rippling is absent from the electrodes sidewalls (421) and the sidewalls (421) have smooth appearance. Further referring to FIG. 4C, the described Cryo-DRIE process involves a high sticking coefficient of oxygen on the silicon layer (410) surface at lower temperatures (e.g., 4 K). The substrate (412) is on a chuck that is cooled with Helium (He) and as a result, the formation of an SiOₓF_{y} passivation layer is enhanced, which minimizes the lateral etch rate. At such low temperatures, the probability of fluorine radicals reacting with Si is also reduced, resulting in a decrease in the chemical contribution to the etching process.

With reference to FIG. 4D, in a substantially similar way as described with reference to FIG. 4C, the applicants have experimented with etching thick metal films, such as Nb (approximately 0.8 μm thick) using ICP etchers to control undercut and to form near-vertical sidewalls of high aspect ratio nanoelectrodes. A Unaxis Chlorine ICP etcher (P-6692) was then utilized, where a ratio of BCl₃ and Cl₂ was controlled carefully to form smooth sidewalls, primarily attributed to BCl₃, without compromising etch rates, determined mainly by the ratio of Cl₂. Etching conditions were: BCl₃ at 30 sccm, Cl₂ at 15 sccm, ICP power of 200 W, bias power is 100 W for strike step and 30 W during etching, and the pressure is 5 mTorr. The etch rate of Nb was approximately 700 A/min, and a clear end point signal is observed upon reaching a subsequent layer (SiO₂ in this case). A soak in DI water (approximately 5 min) was implemented to minimize the potential for corrosion of the electrodes (Nb) with Cl radicals upon exposure to water vapor at ambient. A remaining AZ 8250 resist was then stripped in warm acetone, Microstrip 2001, and an oxygen plasma (approximately 100 W bias power, 150 mTorr of Ar for 3 min) was used to remove the remaining resist. The etching of the Nb film (421) showed excellent selectivity toward the thermal SiO₂ layer (422). After the etch was complete, the thermal SiO₂ layer (422) was coated with an AZ 8250 resist to perform etching on the thermal SiO₂ layer (422) in a CHF₃/O₂ plasma chemistry (40 sccm/2 sccm), 10 mTorr of pressure, 400 W of ICP power, 25 W of bias power). The etching on the thermal SiO₂ layer (422) also showed good selectivity toward the underlying Si substrate (423). FIG. 4B shows an SEM image of electrodes with smooth and vertical sidewalls.

In what follows, fabrication of catalyst nanoclusters within 3D, high aspect ratio nanoscale architectures such as electrodes is described. Referring to FIG. 4A, it will be assumed that high aspect ratio electrodes (420) are already fabricated based on the techniques described with reference to FIGS. 4A-D and procedures to provide a catalyst nanocluster precisely centered in between the two electrodes (420) as shown in FIG. 4A will be described. As an example, generating a 300 nm wide nanocluster at the bottom of a 3 μm deep trench is possible with such fabrication techniques.

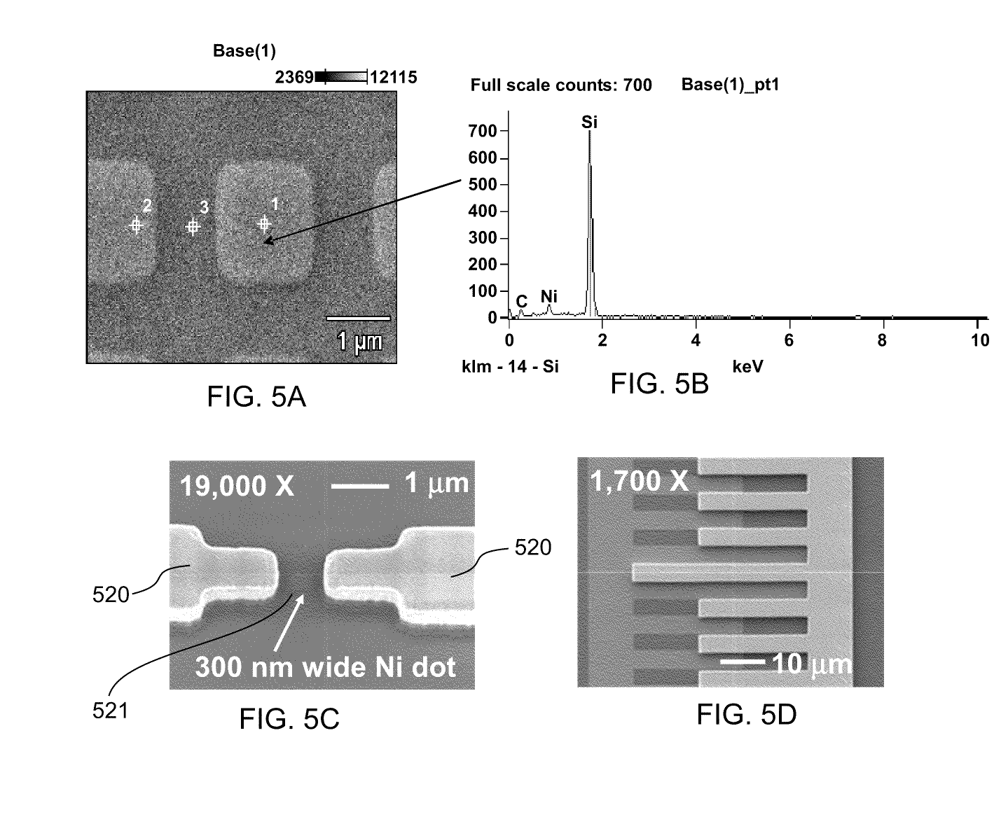

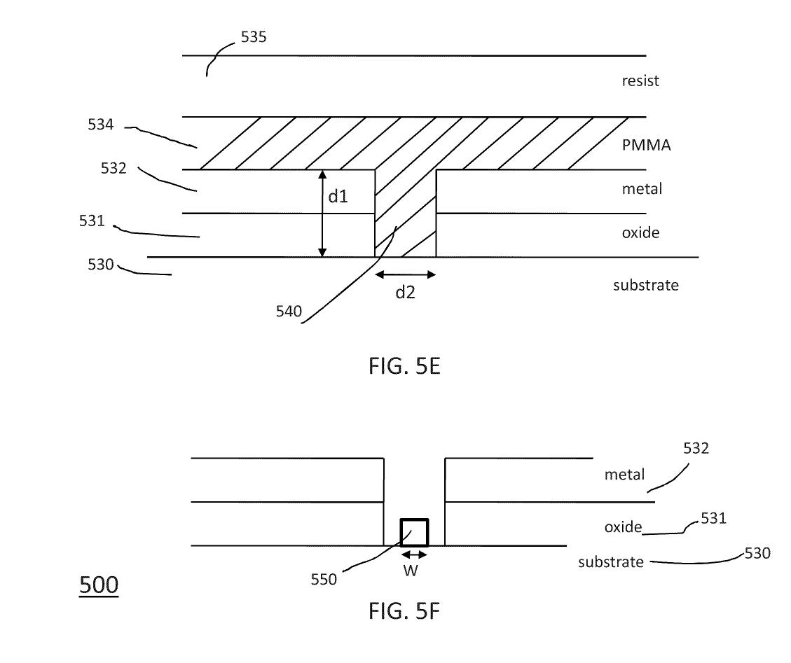

FIG. 5C shows two electrodes (520) with a catalyst nanocluster (521) in between the two electrodes (520). According to an embodiment of the present disclosure, the catalyst nanocluster (521) can be made of Ni and is patterned by lift-off as a result of which, less chemical residues on a Ni surface will be left by eliminating etch by-products.

FIG. 5E shows a cross sectional view of a wafer (500) comprising bilayer stack of a metal layer (532) over an oxide layer (531) on a Si substrate (530). For the sake of representing high aspect ratio nanostructures such as the electrodes (520) of FIG. 5C, a trench (540) of depth d1 (e.g., 3 μm) and of width d2 (e.g., 800 nm) is also shown in FIG. 5E. As shown in FIG. 5E, the wafer (500) is coated with a poly methyl methacrylate (PMMA) under-layer (534), a role of which is described later.

Referring to FIGS. 5E-F, a deep ultraviolet (UV) (e.g., λ=248 nm) eximer laser lithography tool (Canon FPA-3000 EX3 stepper) is used to expose a negative tone polyhydroxystyrene resin-based deep UV chemically amplified resist (535), e.g., UVN 30, to pattern a nanocluster catalyst (550) as shown in FIG. 5F. Throughout the present disclosure, the term “negative tone resist” intends to indicate that the regions that are exposed to UV radiation are insoluble in developer solution. According to an embodiment of the present disclosure, spin-coating can be used to deposit the resist (535) and the PMMA under-layer (534). Other embodiments can be envisaged where shorter laser wavelength (e.g., λ=198 nm, ArF line) can also be used to yield even smaller feature sizes (e.g., <200 nm). The PMMA under-layer (534) of FIG. 5E is used to act as a mechanical buffer to planarize the trench (540) to some extent. A viscosity of the PMMA under-layer (534) is optimized to form a 0.7 μm thick layer. Physical etching in an oxygen plasma is then used to transfer patterns produced on the resist (535) into the PMMA under-layer (534). An interface layer arising from the diffusion of the PMMA under-layer (534) into the resist (535) is also removed during oxygen plasma etching. Exposure of the PMMA under-layer (534) to broadband UV radiation and subsequent emersion in toluene (e.g. 40-50 seconds) ensures that any unetched PMMA gets removed. In accordance with an embodiment of the present disclosure, a Ni film is then e-beam evaporated to a thickness ranging, for example, from 5 to 15 nm at a certain deposition rate (e.g., 2 Angstroms/sec). The resist (535) and the PMMA under-layer (534) are then lifted off in acetone. FIG. 5F shows the wafer (500) after deposition of the nanocluster catalyst (550). The person skilled in the art will appreciate that the nanocluster catalyst (550), having a width of 300 nm, is deposited in the trench (540) which can be up to 3 μm high.

Referring to FIGS. 5C-F, since the wafer (500) had been exposed to various Chlorine and Fluorine ICP etch chemistries in up-stream processing for patterning the electrodes (520) of FIG. 5b, a surface of the catalyst nanocluster (521) was examined with Energy-Dispersive-Spectroscopy (EDS) to see if such impurities could be detected, since the presence of certain impurities can adversely impede tube growth. Referring to FIG. 5A-B, an EDS spectra shown in FIGS. 5B reveals mostly Si, C and Ni, and suggests minimal process residues (to within few percent resolution) on the surface of the Ni catalyst film. The catalyst nanocluster (521) shown in FIG. 5C is 300 nm in diameter fabricated and centered at the bottom of a 1.2 μm trench, as defined by the electrodes (520). Registration marks shown in FIG. 5D indicate that the nanocluster (521) can be centered between the two electrodes (520) with excellent layer-to-layer registration.

Referring to FIG. 5F, after the nanocluster (550) is defined, the wafer (500) can be served as a sample ready to be used for CNT growth according to the methods described with reference to FIG. 1. The person skilled in the art will appreciate that a use of Nb to produce 3D nanostructures such as the electrodes (521) of FIG. 5C will make these nanostructures chemically compatible with tube synthesis as Nb does not poison the CNT growth. Also, Nb is corrosion resistant and resists a corrosive environment arising from the use of reducing gases such as NH₃. Moreover, Nb is thermally compatible with the high temperature tube synthesis environment as described with reference to FIG. 1. In other words, Nb does not delaminate as a result of mis-match in coefficient of thermal expansion between a Si substrate and Nb. The deposition conditions of Nb were carefully chosen so that near-zero film stresses existed during dc magnetron sputtering, by adjusting the Ar pressure and power during growth and as a result, chances for Nb film delamination to occur at elevated temperatures is minimized.

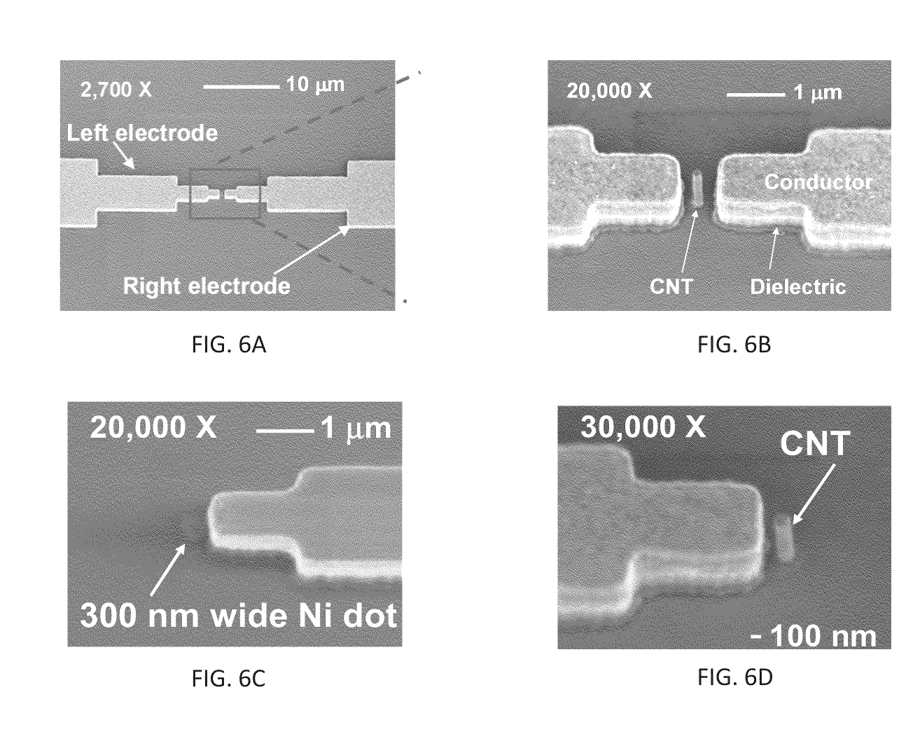

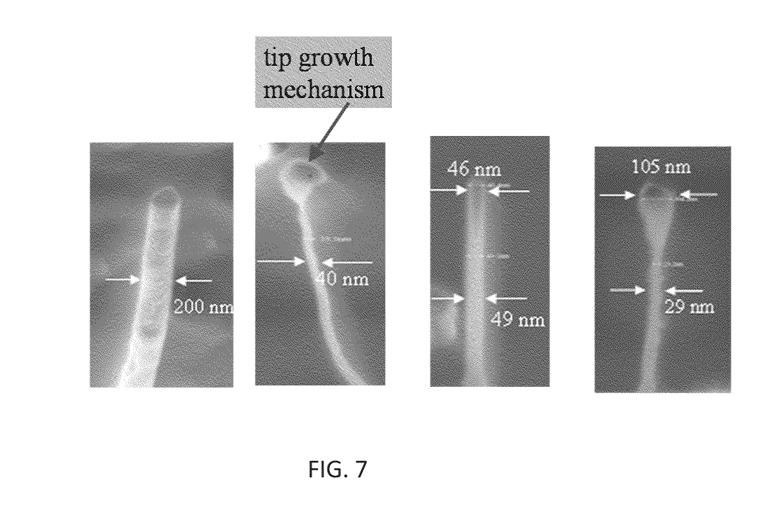

FIGS. 6A-B are respectively low magnification and high magnification SEM images showing two electrodes (610) comprising bilayer stacks of a deposited Nb on thermal SiO₂. FIG. 6B also shows a single, vertically aligned CNT that is centered, and placed within approximately 300 nm of each of the electrodes (610). The electrodes (610) are approximately 1.2 μm tall. FIG. 6C shows a 300 nm diameter nanocluster catalyst at the bottom of a trench just prior to CNT growth. FIG. 6d shows the nanocluster catalyst of FIG. 6C after the growing into a nanotube where the nanotube is precisely centered and is less than 200 nm away from an electrode. The alignment accuracy depicted by the images of FIGS. 6A-D is fairly representative of that obtained using a Canon Stepper, provided a daily calibration routine (lasting˜15 min.) is performed. Typically, the 3σ overlay error of the Canon FPA-3000 is <<50 nm. The person skilled in the art will appreciate that, the fabrication techniques described so far to vertically align PECVD grown tubes and to integrate the tubes with 3D nanoscale architectures are completely amenable to high throughput, low-cost nano-manufacturability.

In what follows, methods to engineer nanotube characteristics with PECVD growth parameters will be described.

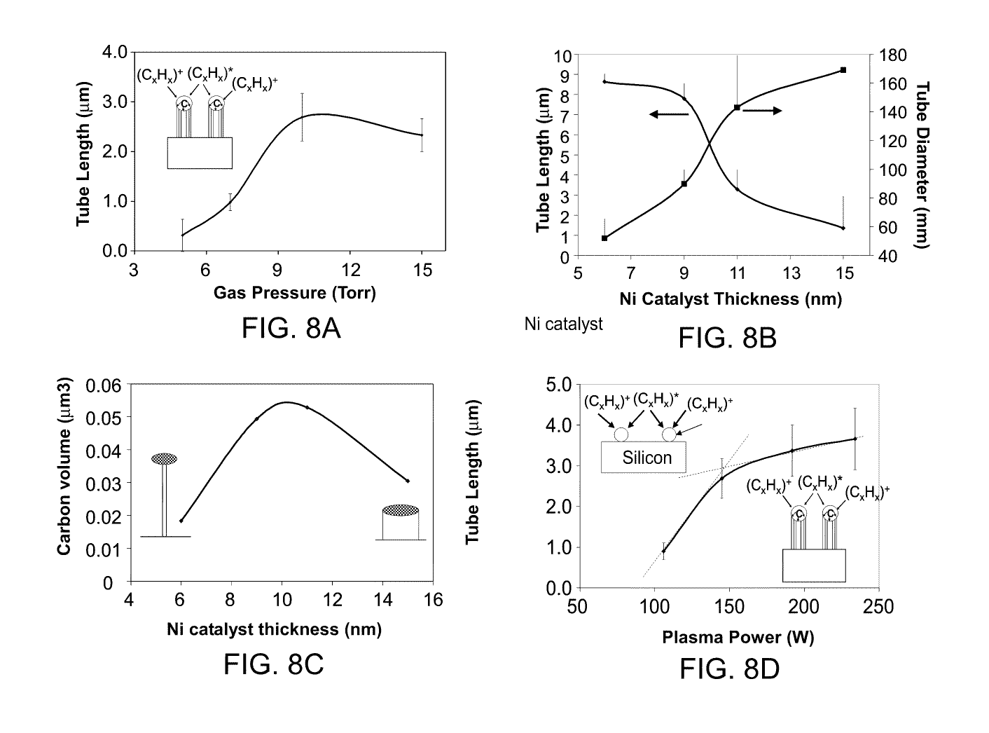

FIG. 8A shows a plot of tube growth vs. gas pressure. As can be seen in FIG. 8A, the tube growth increases with increasing pressure up to about 10 Torr, after which point the tube growth is saturated. As shown in FIG. 8B, a thickness of a Ni catalyst layer strongly affects the physical characteristics of the resulting tubes. Results shown by the plots in FIG. 8B suggest that a thin Ni catalyst film (e.g., 5 nm) nucleated tubes that were thinner and longer, while a catalyst film that was thick (e.g., 15 nm) nucleated tubes that were shorter and wider. The ensuing carbon volume was plotted as a function of catalyst thickness, as shown in FIG. 8C, where the carbon volume was derived from the measured tube dimensions (approximating the tube as a filled cylinder). A maximum in carbon volume was attained at a catalyst thickness of approximately 10 nm. The effect of plasma power on tube growth is shown in FIG. 8D. Referring to FIG. 1, the dc power supply (170) is operated in constant current mode and the power is computed based on the voltage drop between the cathode (120) and anode (150). As shown in FIG. 8D, for low powers below about 140 W, the growth rate is significantly reduced, with little change beyond this point up to about 240 W. It is likely that below approximately 140 W in the chamber (110), the density of an important species required for the synthesis of our tubes is significantly reduced, which reduces growth rates (see reference 13, incorporated herein by reference in its entirety).

Approaches to form single, vertically aligned tubes in 3D nanoscale architectures using high throughput nanomanufacturable techniques were described. The described approaches employ chemically amplified polyhydroxystyrene resin-based deep UV resists for deep submicron feature size resolution. Such resist systems, coupled with state-of-the-art high density, low pressure plasma etching techniques afford top-down approaches for forming high aspect ratio, nanoscale structures, which can then be integrated with PECVD grown tubes using bottom-up synthesis. The developed approaches can precisely control and integrate single, aligned PECVD grown nanotubes into 3D nanoscale architectures using low-cost, high-throughput wafer-scale techniques that should accelerate development for a broad range of applications, such as nano-electro-mechanical-systems (NEMS), interconnects, sensors, and 3D electronics in general.

The present disclosure has shown nanotubes and related fabrication processes. While the nanotubes and related fabrication processes have been described by means of specific embodiments and applications thereof, it is understood that numerous modifications and variations could be made thereto by those skilled in the art without departing from the spirit and scope of the disclosure. It is therefore to be understood that within the scope of the claims, the disclosure may be practiced otherwise than as specifically described herein.

### LIST OF REFERENCES

1. J. Li, Q. Ye, A. Cassell, H. T. Ng, R. Stevens, J. Han, and M. Meyyappan, Appl. Phys Lett. 82, 2491 (2003).
2. Bachtold, P. Hadley, T. Nakanishi, and C. Dekker, Science 294, 1317 (2001).
3. Yu, S. Saha, J. Zhou, L. Shi, A. Cassel, B. A. Cruden, Q. Ngo, and J. Li, Transactions of the ASME 128, 234 (2006).
4. Q. Ngo, B. A. Cruden, A. M. Cassell, G. Sims, M. Meyyappan, J. Li, and C. Y. Yang, Nano Lett. 4, 2403 (2004).
5. Z. F. Ren, Z. P. Huang, J. W. Xu, J. H. Wang, P. Bush, M. P. Siegal, and P. N. Provencio, Science 282, 1105 (1998).
6. D. Nolan, D. C. Lynch, and A. H. Cutler, J. Phys. Chem. B 102, 4165 (1998).
7. V. Melechko, V. I. Merkulov, T. E. McKnight, M. A. Guillorn, K. L. Klein, D. H. Lowndes, and M. L. Simpson, J. Appl. Phys. 97, 041301 (2005).
8. X. Zhang, S. Prasad, S. Niyogi, A. Morgan, M. Ozkan, and C. Ozkan, Sens. Actuators B 106, 843 (2005).
9. K. B. K. Teo, S. B. Lee, M. Chhowalla, V. Semet, V. T. Binh, O. Groening, M. Castignolles, A. Loiseau, G. Pirio, P. Legagneux, D. Pribat, D. G. Hasko, H. Ahmed, G. A. J. Amaratunga and W. I. Milne, Nanotech. 14, 204 (2003).
10. S. Helveg, C. Lopez-Cartes, J. Sehested, P. Hansen, B. Clausen, J. Rostrup-Nielson, F. Abild-Pedersen and J. Norskov, Nature 427, 426 (2004).
11. O. Louchev, Y. Sato, and H. Kanda, Appl. Phys. Lett. 80, 2752 (2002).
12. M. Chhowalla, K. B. K. Teo, C. Ducati, N. L. Rupesinghe, G. A. J. Amaratunga, A. C. Ferrari, D. Roy, J. Robertson, and W. I. Milne, J. of Appl. Phys. 90, 5308 (2001).
13. B. A. Cruden, A. M. Cassell, Q. Ye, and M. Meyyappan, J. Appl. Phys. 94, 4070 (2003).

1. A method for fabricating vertically aligned carbon nanotubes comprising:
providing a growth chamber;
providing a sample wafer comprising a catalyst patterned on a substrate inside the chamber;
reducing a surface oxide on the catalyst by performing a pretreatment with hydrogen plasma at a pretreatment temperature;
setting chamber temperature at a growth temperature;
setting chamber pressure to a desired chamber pressure to introduce a carbon containing gas and a diluent gas into the chamber;
introducing the carbon containing gas and the diluent gas into the chamber;
setting the chamber pressure to a growth chamber pressure;
initiating a growth of the vertically aligned nanotubes from the catalyst by igniting an electric glow discharge; and
continuing the growth for a set duration.

2. The method of claim 1, wherein the substrate is a 2D planar substrate or a substrate comprising pre-fabricated 3D features.

3. The method of claim 2, wherein the pre-fabricated 3D features are high aspect ratio features.

4. The method of claim 3, wherein the high aspect ratio features are multi-layer electrodes comprising each a stack of a deposited device layer on an oxide layer.

5. The method of claim 4, wherein the electrodes are up to 3 μm high and placed within a less than 800 nm distance from one another.

6. The method of claim 4, wherein the device layer is made of Nb or degenerately doped Si.

7. The method of claim 4, wherein the oxide layer is made of thermal SiO₂ or the oxide layer is a Buried Oxide (BOX) sandwiched in between the device layer and a Si handle serving as the substrate.

8. The method of claim 4, wherein the catalyst comprises a plurality of nanoclusters placed in between the electrodes.

9. The method of claim 8, wherein the nanoclusters are less than 200 nm wide.

10. The method of claim 8, wherein the nanoclusters are placed within a distance of 100 nm or more from one or more of the electrodes.

11. The method of claim 1, wherein the catalyst is at isolated locations on the substrate or arranged in an array configuration across the entire sample wafer.

12. The method of claim 1, wherein the catalyst is made of Ni, Fe, Co, or Cu.

13. The method of any of claims 1, wherein the chamber desired temperature is 700° C. or less.

14. The method of claim 1, wherein the carbon feedstock gas is ethylene (C₂H₄) or methane (CH₄) and the diluent gas is ammonia (NH₃) or hydrogen (H₂).

15. The method of claim 14, wherein C₂H₄ and NH₃ are used in a ratio of C₂H₂:NH₃=1:4.

16. A method of fabricating high aspect ratio nanostructures comprising:
providing a wafer comprising a substrate, the substrate underlying a stack of a deposited device layer on an oxide layer;
coating the wafer with an under-layer;
coating the under-layer with a positive tone chemically amplified resist;
defining the structures by patterning and exposing the positive tone chemically amplified resist;
developing the positive tone chemically amplified resist;
etching the device layer;
minimizing a lateral etch rate by enhancing a formation of a passivation layer;
forming the high aspect ratio nanostructures with widths of less than 400 nm;
recoating the wafer with the positive tone chemically amplified resist; and
etching the oxide layer.

17. The method of claim 16, wherein the etching is a Cryogenic deep-trench reactive ion etching (Cryo-DRIE) and inductively coupled plasma (ICP) etching.

18. The method of claim 17, wherein the device layer is a degenerately doped Si layer and the oxide layer is a Burried-Oxide (BOX) layer.

19. The method of claim 18, wherein the etching is performed using a combination of O₂ and SF₆.

20. The method of claim 16, wherein the formation of the passivation layer is enhanced by cooling the wafer substrate.

21. The method of claim 20, wherein the cooling is performed using a Helium (He) chuck.

22. The method of claim 18, wherein the stack is etched up to 3 μm to reach the substrate.

23. The method of claim 16, wherein the under-layer is made of poly methyl methacrylate (PMMA).

24. The method of claim 16, wherein the positive tone chemically amplified resist and the under-layer are spin-coated.

25. The method of claim 17, wherein the device layer is of metal and the oxide layer is a thermal SiO₂ layer.

26. The method of claim 25, where the metal is Nb.

27. The method of claim 25, wherein a desired ratio of BCl₃ and Cl₂ is used for the etching the metal.

28. The method of claim 25, wherein a CHF₃/O₂ plasma chemistry is utilized for the oxide etching.

29. A method of fabricating catalyst nanoclusters within high aspect ratio 3D nanostructures comprising:
providing a wafer comprising high aspect ratio nanostructures on a substrate;
providing a catalyst;
coating the wafer with an under-layer;
coating the under-layer with a negative tone chemically amplified resist;
defining nanocluster patterns and exposing the negative tone chemically amplified resist to broadband ultraviolet (UV);
developing the negative tone chemically amplified resist;
re-exposing the wafer to broadband UV;
dissolving a remaining of the under-layer;
depositing the catalyst nanoclusters;
monitoring a thickness of the catalyst nanoclusters until a desired thickness is reached;
cooling the wafer; and
lifting off the remaining of the under-layer and the negative tone chemically amplified resist.

30. The method of claim 29, wherein the catalyst nanoclusters are deposited using e-beam evaporation.

31. The method of claim 30, wherein the catalyst nanoclusters are e-beam evaporated to a thickness ranging from 5 to 15 μm.

32. The method of claim 30, wherein the catalyst nanoclusters are 200 nm wide in diameter.

33. The method of claim 29, wherein the high aspect ratio 3D nanostructures are multi-layer electrodes comprising each a stack of a deposited device layer on an oxide layer.

34. The method of claim 33, wherein the electrodes are up to 3 μm high and placed within a less than 800 nm distance from one another.

35. The method of claim 34, wherein the catalyst nanoclusters are deposited in between the electrodes within a distance of 100 nm or more from some of the electrodes.

36. A 3D nanostructure comprising:
a substrate underlying two multi-layer electrodes comprising each a stack of a deposited device layer on an oxide layer; and
a single vertically aligned nanotube centered between the two electrodes,
wherein the two electrodes are up to 3 μm high and are less than 800 nm apart from each other, and
the nanotube is less than 300 nm wide and placed at a distance of of 100 nm or more from any of the two electrodes.

37. The 3D nanostructure of claim 36, wherein the substrate is a silicon substrate, the device layer is a degenerately doped silicon layer, the oxide layer is a Buried Oxide (BOX) layer, and the nanotube is made of metal.

38. The 3D nanostructure of claim 36, wherein the substrate is a silicon substrate, the device layer is made of Nb, the oxide layer is a thermal SiO₂ layer, and the nanotube is made of Ni.

39. A 3D nanoarchitecture comprising:
a plurality of nanostructures on a substrate, each of the plurality of nanostructures comprising:
two multi-layer electrodes each comprising a stack of a deposited device layer on an oxide layer; and
a single vertically aligned nanotube centered between the two electrodes,
wherein the electrodes are up to 3 μm high and are less than 800 nm apart from each other, and
the nanotube is less than 300 nm wide and placed in a distance 100 nm or more from any of the two electrodes.

40. The 3D nanoarchitecture of claim 39, wherein the substrate is a silicon substrate, the device layer is a degenerately doped silicon layer, the oxide layer is a Buried Oxide (BOX) layer, and the nanotube is made of metal.

41. The 3D nanoarchitecture of claim 39, wherein the substrate is a silicon substrate, the device layer is made of Nb, the oxide layer is a thermal SiO₂ layer, and the nanotube is made of Ni.

42. The method of claim 1, wherein the chamber pressure is controlled to a set value to fabricate vertically aligned carbon nanotubes of a desired length.

43. The method of claim 1, wherein a plasma power is controlled to a set value to fabricate vertically aligned carbon nanotubes of a desired length.

44. The method of claim 1, wherein the catalyst has a set thickness to generate vertically aligned carbon nanotubes of a desired diameter.
